(19) United States
(12) Patent Application Publication
(10) Pub. No.: US 2017/0142084 A1
(43) Pub. Date: May 18, 2017

(54) Systems and Methods for Employing RSA Cryptography

(71) Applicant: Mark Nataros, Austin, TX (US)

(72) Inventor: Mark Nataros, Austin, TX (US)

(21) Appl. No.: 15/350,046

(22) Filed: Nov. 12, 2016

Related U.S. Application Data
(60) Provisional application No. 62/254,688, filed on Nov. 12, 2015.

(51) Int. Cl. H04L 29/06

(52) U.S. Cl. CPC H04L 63/061; H04L 63/0442; H04L 63/0435; H04L 63/123

(57) ABSTRACT

A system that includes a client front end, a client server, and an authentication server, wherein the authentication server is configured to contains a public key to be employed for encryption of a license key, and the client server is configured to contain a private key to be employed for decryption of the license key.

### STATEMENT OF PRIORITY

The present application claims priority to U.S. Provisional Application No. 62/254,688, titled “Systems and Methods for Employing RSA Cryptography” and filed Nov. 12, 2015.

### TECHNICAL FIELD

The present disclosure relates to cryptography and, more specifically, to employing RSA in a unique fashion to preclude imitation of the encryption source.

### BACKGROUND

Cryptography, or the encryption and decryption of data, is a necessary tool for any modern day business. To reduce, and hopefully prevent altogether, the likelihood of data being stolen or “hacked,” all systems transferring data over a network, and especially the internet, should employ a cryptography scheme.

In one of the most simple fashions, some companies “encrypt” licenses by shipping their software with a stored table of valid licenses, and then ship a valid license key with the product. Upon installing the software, the consumer is prompted for a license key, for example a series of 10 alpha numeric entries (e.g., 12345ABC67). Upon entering the license key into the software, it is checked against the stored table and, if valid, the software is enabled. This has numerous downsides, such only allowing a limited number of keys due to being in a pre-stored table shipped with the software, and also requiring a large amount of hard drive space to store the license key table.

In another configuration, a system may include a license server and a client (or user) front end, such as a computer, laptop, tablet, iPad, etc. In such a configuration, the license server sends an encrypted license to the client front end which runs software capable of decrypting the license, thereby allowing the software to run. However, a problem arises if a user learns how to decrypt the license outside of the software. There is no other security protecting the license, and thus the user could edit it to be valid virtually indefinitely.

Even further approaches may be employed which require a login and, based upon a successful login, configure a session stream between the server and the client. However, this presents other issues as it is still a client-server based communication. For example, such a system is not feasible for configurations that include separate authentication and data servers, thereby requiring the client to communicate and be authenticated by the authentication server, but establish streaming communication with the data server.

One well known cryptography method is RSA. In sum, RSA involves a “public key,” a “private key,” and a cryptography scheme which involves related prime numbers and a predetermined modulus number, as known to those skilled in the art. The public key is known to all users and employed for encrypting messages prior to being sent to a receiving machine. The private key is only known by the receiving machine, which is typically a server, licensing machine, or the like, thereby enabling decryption of the received encrypted messages. Such a system is advantageous when desiring to allow multiple users to send encode messages, but only a single machine to decode the received messages. Moreover, as the “public key” is generally given out willingly, obtainment of such by a non-authorized user is far less concerning than obtainment of the private key. Should a non-authorized user obtain the public key, all that can happen is the sending of fake messages to the server. However, the non-authorized user is still precluded from decoding the messages from all other users, ensuring data integrity, such as login user names and passwords, is maintained. Unfortunately, such a scheme is not viable for systems which desire to ensure a message is being encoded and sent from a single, known machine.

Accordingly, an improved system for assuring only a known machine can encrypt data remains highly desirable.

### BRIEF DESCRIPTION OF THE DRAWINGS

The following figures are included to illustrate certain aspects of the present invention, and should not be viewed as an exclusive embodiments. The subject matter disclosed is capable of considerable modification, alteration, and equivalents in form and function, as will occur to one having ordinary skill in the art and the benefit of this disclosure.

FIG. 1 is an authentication and data sharing system, according to one or more embodiments.

FIG. 2 is a block diagram of a computing device, according to one or more embodiments.

### DETAILED DESCRIPTION

The present disclosure relates to cryptography and, more specifically, to employing RSA in a unique fashion to preclude imitation of the encryption source. In one embodiment, the present disclosure includes a system that employs a client server running software which requires a license. The system further includes an authentication server which provides the client server with valid licenses, thereby enabling a client front end connected to the client server to use the software installed thereon.

It is important to ensure that the license was actually generated by the authentication server (or, in other words, that only the authentication server is capable of sending the license). Therefore, in one embodiment, RSA encryption is employed in a “reverse” fashion, where the public key employed for encryption is known only by the authentication server, and the private key enabling decryption is known by each receiving device. Even if an unauthorized user obtains the private decryption key, and is therefore capable of decrypting the license, such is meaningless and fails to provide an advantage as the unauthorized user is still unable to generate or mimic an encrypted license as generated by the authentication server, and thus the software of the client server will not operate.

As used herein, a “processor” may be comprised of, for example and without limitation, one or more processors (each processor having one or more cores), microprocessors, field programmable gate arrays (FPGA's), application specific integrated circuits (ASICs) or other types of processing units that may interpret and execute instructions as known to those skilled in the art.

As used herein, “memory” may be any type of storage or memory known to those skilled in the art capable of storing data and/or executable instructions. Memory may include volatile memory (e.g., RAM), non-volatile memory (e.g., hard-drives), or a combination thereof. Examples of such include, without limitation, all variations of non-transitory computer-readable hard disk drives, inclusive of solid-state drives. Further examples of such may include RAM external to a computer or controller or internal thereto (e.g., “on-board memory”). Example embodiments of RAM may include, without limitation, volatile or non-volatile memory, DDR memory, Flash Memory, EPROM, ROM, or various other forms, or any combination thereof generally known as memory or RAM. The RAM, hard drive, and/or controller may work in combination to store and/or execute instructions.

Referring now to the drawings, wherein like reference numbers are used herein to designate like elements throughout the various views and embodiments of a unit. The figures are not necessarily drawn to scale, and in some instances the drawings have been exaggerated and/or simplified in places for illustrative purposes only. One of the ordinary skill in the art will appreciate the many possible applications and variations based on the following examples of possible embodiments. As used herein, the “present disclosure” refers to any one of the embodiments described throughout this document and does not mean that all claimed embodiments must include the referenced aspects.

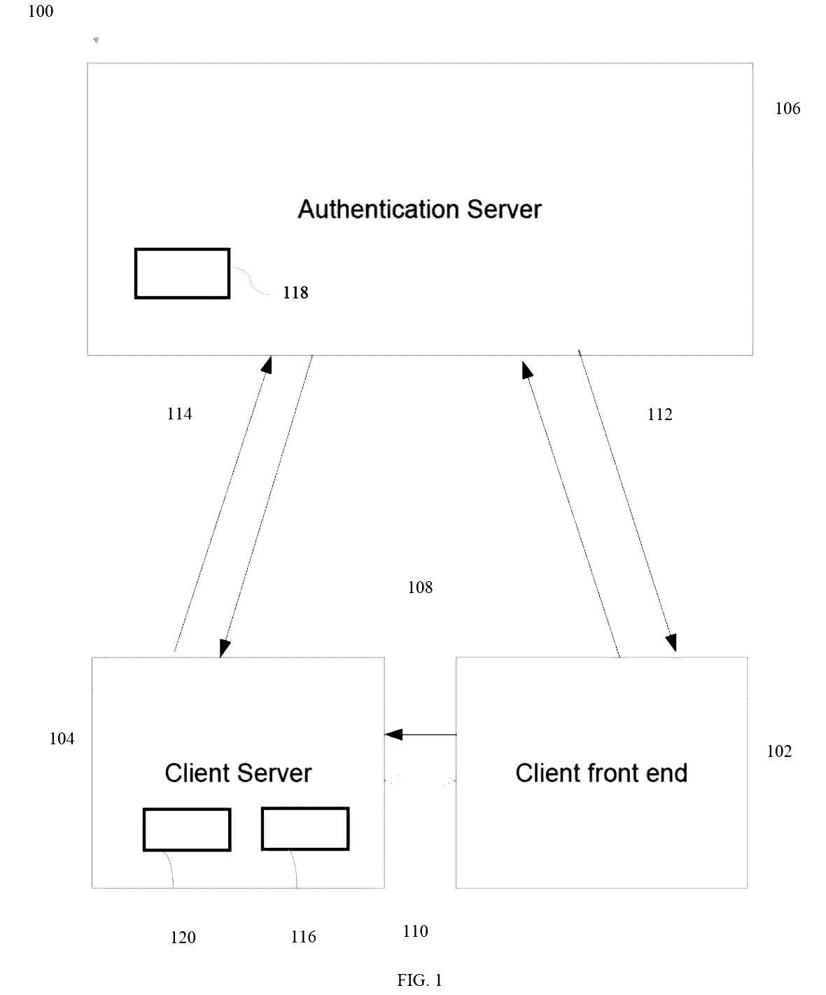

FIG. 1 depicts an authentication and data sharing system 100, according to one or more embodiments. As depicted, the system 100 includes a client front end 102, a client server 104, and an authentication server 106. For example and without limitation, the client front end 102 may be a desktop computer, or may be a more portable computing device, such as a laptop, tablet, iPad, cellular telephone, or the like. The client server 104 host is the primary computer in which the client front end 102 communicates with. The client server 104 may be any type of server known to those skill in the art, including but not limited to, a desktop server, blade server, or cloud computing network. The authentication server 106, detailed below, is responsible for initially configuring communication between the client front end 102 and the client server 104, and additionally sending license keys (and updated licenses) to the client server 104. Similar to the client server 104, the authentication server 106 may be, for example and without limitation, a desktop server, blade server, or cloud computing network. Moreover, in some embodiments, the authentication server 106 may be a separate computer from the client server 104, while in other embodiments, the client server 104 and the authentication server 106 may be hosted or run on the same server hardware.

While FIG. 1 depicts an embodiment containing only a single client front end 102, client server 104, and authentication server 106, such should not be construed as limiting. One of skill in the art will readily appreciate that other embodiments of the system 100 may include numerous client front ends 102, client servers 104, and/or authentication servers 106.

The client front end 102 is communicably coupled to the client server 104 via a first communication channel 108. Upon a successful connection with the client server 104, a pipe or data stream 110 is established therebetween which transfers a substantial majority of the data. The client front end 102 is further communicably coupled to the authentication server 106 via a second communication channel 112. As discussed in detail below, the client front end 102 requests an available client server 104 from the authentication server 106. Upon determination of such, the authentication server 106 transfers a “one-time password key” to the client front end 102 via the second communication channel 112. The client front end 102 can then use the one-time pass key to access the client server 104. The system 100 further includes a third communication channel 114 between the authentication server 106 and the client server 104. The third communication channel 114 can be used to register the client server 104 with the authentication server 106, and for the authentication server 106 to send licenses to the client server 104.

In one exemplary operation, after the authentication server 106 has booted up and after the client server 104 has booted up, a secure connection is established therebetween via the third communication channel 114. During or shortly after the established connection, the client server 104 may communicate information to the authentication server 106, such as the client server's 104 specifications, unique ID, or other information enabling the authentication server 106 to recognize the client server 104. The client server 104 also sends the authentication server 106 the one-time password key 116, discussed below. The authentication server 106 takes this information and may determine a particular set or subset of client front ends 102 which will be allowed to connect to the client server 104.

The client front end 102 also connects to the authentication server 106, doing so via the second communication channel 112. In one embodiment, the client front end 102 sends information to the authentication server 106 such as a user name and login password. Upon approval of the client front end 102 credentials, the authentication server 106 may return a list of client servers 104 available which the client front end 102 may use. The client front end 102 (or user thereof) selects which client server 104 they so desire, and such a selection is returned to the authentication server 106. The authentication server 106 then sends the one-time password key 116 associated with that client server 104 to the client front end 102, where the client front end 102 then further transfers the one-time password key 116 to the client server 104, thereby authenticating and/or allowing the client front end 102 to login, gain access, and/or take control of the client server 104.

In the process of the client front end 102 establishing a connection with the client server 104, the client server 104 also obtains a license from the authentication server 106. In further detail to that described above, such is securely accomplished via a “reverse” RSA methodology, wherein the authentication server 106 has stored thereon a public key 118 used for encryption, and the one or more client server(s) 104 includes a private key 120 used for decryption.

It is important to ensure that the license was actually generated by the authentication server 106 (or, in other words, that only the authentication server is capable of sending the license). With the reverse RSA implementation described and discussed herein, even if an unauthorized user obtains the private decryption key, and is therefore capable of decrypting the license, such is meaningless and fails to provide an advantage as they are still unable to generate or mimic an encrypted license as generated by the authentication server, and thus the software of the client server will not operate.

In one embodiment, the license is time-based, wherein the license is valid between a particular date and time. For example, a license may be valid from 2 pm UTC to 3 pm UTC time on a particular day. The client server 104 periodically attempts to obtain a new license from the authentication server 106 prior to expiration of the current license. However, advantageously, failure to obtain a renewed license on the initial attempts does not shut down the client server 104. Continuing from the previous example, if the current license is valid from 2 pm UTC to 3 pm UTC, the client server 104 may initially request a renewed license from the authentication server 106 at 1:15 pm UTC. If such a request fails, for example, because the authentication server is offline for maintenance, the client server 104 continues to run because the current license key is still valid until 3 pm UTC. Multiple additional attempts can be made for the client server 104 to attempt to obtain a renewed license. Only if the current license expires before renewed will the client server 104 shut down and cease to operate.

Advantageously, in some embodiments, there can be numerous public key 118 and private key 120 combinations. For example, one combination could be used to distribute a private key 120 only to a subset or particular client server's 104. Moreover, certain private key 120 may be associated with certain subsets of client who only receive a limited license, for example, only unlocking portions of the software running thereon. Alternatively, various public key 118 and private key 120 combinations may be employed simply for increased security, this way if one private key 120 is stolen or hacked by an unauthorized user, only a subset of client servers' 104 are even remotely at risk of having imitation licenses. In further embodiments, the public key 118 and private key 120 combinations may even be changed “on-the-fly” in a sense that, after an initial valid license is obtained by the client server 104, a second private key 120 may be transferred to the client server 104 at some point for future license renewals.

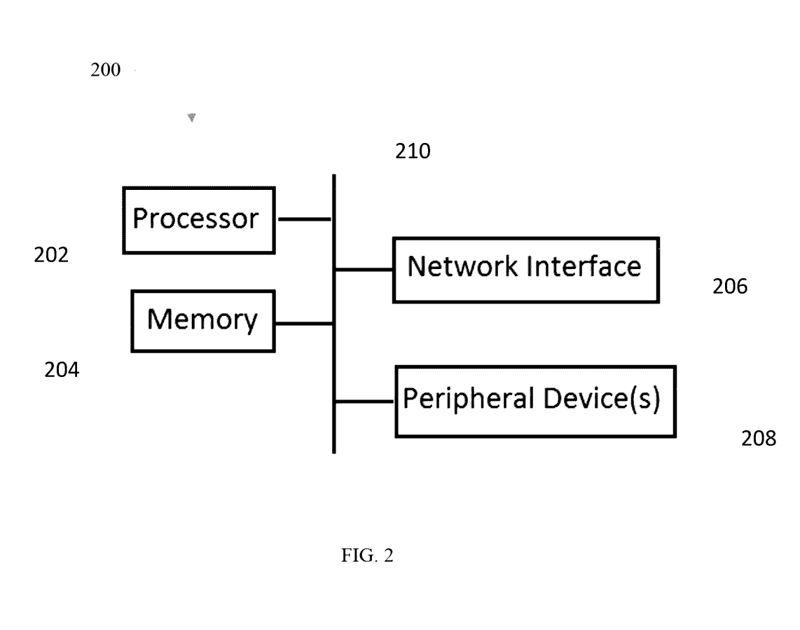

FIG. 2 depicts a block diagram 200 of a computing device that may be employed as one or more of the client front end 102, client server 104, and/or authentication server 106, according to one or more embodiments. In the embodiment depicted, the diagram 200 includes a processor 202, a memory 204, a network interface 206, and one or more peripheral device(s) 208.

The processor 202 may be comprised of, for example and without limitation, one or more processors (each processor having one or more cores), microprocessors, field programmable gate arrays (FPGA's), application specific integrated circuits (ASICs) or other types of processing units that may interpret and execute instructions as known to those skilled in the art. Thus, the processor 202 may be comprised of a central processing unit (CPU) and an accelerated processing unit (APU) or graphics processing unit (GPU), thereby enabling increased ability to perform graphics processing.

The block diagram 200 further includes various types of memory 204, such as a hard drive and/or random access memory (RAM). Hard drive(s) may be any type of memory known to those skilled in the art capable of storing data or executable instructions thereon for a prolonged period of time, and continuing to store such should power to the computer (e.g., the client front end 102, client server 104, or authentication server 106) be turned off. Examples of such include, without limitation, all variations of non-transitory computer-readable hard disk drives, inclusive of solid-state drives. Other embodiments of the memory 204 may alternatively or additionally include random access memory (RAM). RAM may be external to computer, or in other embodiments be internal (e.g., “on-board” memory) to computer, and work in coordination with any hard drive to store and/or execute programs and/or process graphics data, etc. Example embodiments of RAM may include, without limitation, volatile or non-volatile memory, DDR memory, Flash Memory, EPROM, ROM, or various other forms, or any combination thereof generally known as memory or RAM.

The network interface 206 may be any interface capable of sending and receiving data via a network. Examples may include, but are not limited to, hard-wired network interface card(s) (NIC), and/or wireless network interfaces, including those capable of transmitting data over a cellular provider network. The network interface 206 may be configured to communicate over one or more of a local area network (LAN), wide area network (WAN), cellular provider network (or “mobile network”), along with “cloud” networks.

The peripheral device(s) 208 may include, for example and without limitation, a keyboard, mouse, and/or display. For example, the client server 104 and authentication server 106, which, in at least one embodiment are hosted on the same computer, may initially be configured or updated via a locally connected mouse, keyboard, and/or monitor. Alternatively, such may be remotely configured, for example, via a remote login over a network. The client front end 102 may vary from a desktop computer, to a portable computing device such as a laptop, tablet, iPad, etc., to a cellular device. Therefore, in some embodiments, the peripheral device 208 may include a touch screen display or embedded display (e.g., mobile devices).

One or more of the processor 202, memory 204, network interface 206, and peripheral device(s) 208 are communicably coupled via one or more busses 210.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein.

Also, the terms in the claims have their plain, ordinary meaning unless otherwise explicitly and clearly defined by the patentee. Moreover, the articles “a” or “an,” as used in the claims, are defined herein to mean one or more than one of the element that it introduces. As used herein the term “and/or” and “/” includes any and all combinations of one or more of the associated listed items. While compositions and methods are described in terms of “comprising,” “containing,” or “including” various components or steps, the compositions and methods can also “consist essentially of or” consist of the various components and steps.

It will be understood that the sizes and relative orientations of the illustrated elements are not shown to scale, and in some instances they have been reduced or exaggerated for purposes of explanation. Additionally, if there is any conflict in the usages of a word or term in this specification and one or more patent or other documents that may be incorporated herein by reference, the definitions that are consistent with this specification should be adopted.

What is claimed is:

1. A system/method for verifying the identity and time of messages/licenses/communication between systems and or nodes, comprising: creating a network communication pipeline for transmitting the trusted message containing information such as system identification information, permissions information and timing information.

2. The method of claim 1, further comprising: Generating the trusted message using RSA in a unique methodology which allows the destination system or node to read the trusted message using the ‘public’ RSA key (classically defined term for those familiar with cryptology) which is encrypted using the ‘private’ RSA key (classically defined term for those familiar with cryptology). For clarity, in classical cases the ‘public’ RSA key is used for encryption and the ‘private’ RSA key is used for decryption allowing the contents of the message to be secure whereas the identity of the sender is not secure utilizing the traditional RSA method itself which is the reverse of this case.

3. The method of claim 1, further comprising a method of sharing the ‘public’ RSA key which may be done in a secure manner (online via network such as traditional RSA methods for use of transmitting secure data across a network and/or offline via other system file or offline messaging pipelines or means) to prevent unwanted access to the contents of the message.

4. The method claim 1, where we are applying RSA in reverse of the traditional methodology to secure identity over content of message in a computer systems/devices environment.

5. The method claim 1, of utilizing the RSA ‘public’ key to decrypt the message created using the RSA ‘private’ key for use in system and or node identification in a secure manner.
